(19) United States
(12) Patent Application Publication
(10) Pub. No.: US 2020/0270776 A1
(43) Pub. Date: Aug. 27, 2020

(54) SEW FREE INTERIOR WOVEN LABEL AND AUTOMATED APPLICATION

(71) Applicant: AVERY DENNISON RETAIL INFORMATION SERVICES LLC, Mentor, OH (US)

(72) Inventors: Mathieu de Backer, Grottammare (IT); Yael Rosenblum, Allston, MA (US); Barry Van Dyk, Ocean, NJ (US)

(21) Appl. No.: 16/729,703

(22) Filed: Dec. 30, 2019

Related U.S. Application Data
(60) Provisional application No. 62/786,392, filed on Dec. 29, 2018.

(51) Int. Cl. D03D 1/00; D03D 15/00; D06H 1/04; D06H 1/02; G06K 19/02

(52) U.S. Cl. CPC D03D 1/0011; D03D 1/0088; D03D 15/00; D06H 1/046; D06H 1/02; D10B 2401/041; D03D 2700/0174; D10B 2331/04; D10B 2201/02; D10B 2401/18; G06K 19/027

(57) ABSTRACT

A method, system, and apparatus for a sew free seamless interior woven label application may be shown and described. Weaving fusible thermo-adhesive heat seal yarns may be applied to the fold backs of any woven label through an automated process. The woven labels with the fusible thermo-adhesive heat seal yarns may be affixed to the desired garments through an automated process by applying heat to the woven labels, thereby activating the fusible thermo-adhesive heat seal yarns, causing the woven label to become affixed to the desired garment. Such a method, system and apparatus can make the garment manufacturing process and woven label application process more efficient, eliminate waste, enhance visual appeal of the final garment product, and reduce manufacturing costs, among other advantages.

### CROSS REFERNCE TO RELATED APPLICATION(S)

The present application claims priority to and the benefit of U.S. patent application No. 62/786,392 filed Dec. 29, 2018, which is incorporated by reference herein in its entirety.

### BACKGROUND

Currently woven labels for apparel and wearable technology may be attached to their garments or any other sort of material by a standard procedure. The woven labels are created independently of the garments. Once the garment is created into its desired item (e.g., shirt, pant, jacket, etc.), the woven labels are sewn onto or into the garment in the desired locations. After the woven labels are sewn onto the garments, the garments are ready for market.

The current process, which requires each woven label to be sewn onto the individual garment create additional cost, requires additional material, increases overall time of production, and creates opportunity for an increased rate of error. Further, under the traditional method it is time consuming to change the thread used for sewing on different colored woven labels. Also, often the sewing thread stitching is visible on the reverse side of the garment, requiring an extra layer of added material to cover the stitch, or left uncovered being unsightly.

### SUMMARY

To resolve the above issues, a method, system, and apparatus for a sew free seamless interior woven label application may be shown and described. Weaving fusible thermo-adhesive heat seal yarns may be applied to the fold backs of any woven fold type label through an automated process known in the art (e.g. end fold, loop fold, Manhattan fold, Mitre Fold, tri-fold, booklet fold, etc.). The application process can be affixed through automation with a pick and place robotic arm, conveyor, or vacuum applied process to the desired location on the garment/apparel. The registration of the sew free label will be determined through a vision system that localizes the area for attachment on the apparel and will place through a mechanical process. Then a heat-activated bonding solution will adhere the label in its position. Time, pressure, and heat can all be controlled depending on permanent or nonpermanent requirements of label conditions

The woven labels with the fusible thermo-adhesive heat seal yarns may then be affixed to the desired garments through an automated process by applying heat to the woven labels, for example by a heat press available from Avery Dennison Retail Information Services, LLC of Mentor, Ohio, thereby activating the fusible thermo-adhesive heat seal yarns, causing the woven label to become substantially, permanently affixed to the desired garment or if temporary adhesion is required, less heat, pressure or a modified thermally activatable adhesive can be used. Such a method, system and apparatus can make the garment manufacturing process and woven label application process more efficient, eliminate waste, enhance visual appeal of the final garment product, and reduce manufacturing costs, among other advantages.

### BRIEF DESCRIPTION OF THE FIGURES

Advantages of embodiments of the present invention will be apparent from the following detailed description of the exemplary embodiments thereof, which description should be considered in conjunction with the accompanying drawings in which like numerals indicate like elements, in which:

FIG. 1A is an exemplary view of a woven label with the fusible thermo-adhesive heat seal yarns attached.

FIG. 1B is another exemplary view of a woven label with the fusible thermo-adhesive heat seal yarns attached.

FIG. 1C is another exemplary view of a woven label with the fusible thermo-adhesive heat seal yarns attached.

FIG. 2A is an exemplary view of a woven label affixed to a garment by the fusible thermo-adhesive heat seal yarn

FIG. 2B is an exemplary view of a woven label affixed to a garment by the fusible thermo-adhesive heat seal yarn.

FIG. 2C is an exemplary view of a woven label affixed to a garment by the fusible thermo-adhesive heat seal yarn

FIG. 3A is another exemplary view of a woven label affixed to a garment by the fusible thermo-adhesive heat seal yarn.

FIG. 3B is another exemplary view of a woven label affixed to a garment by the fusible thermo-adhesive heat seal yarn.

FIG. 4 is an exemplary view of an applicator machine.

FIG. 5 illustrates a method of making the woven label presently contemplated.

### DETAILED DESCRIPTION

Aspects of the invention are disclosed in the following description and related drawings directed to specific embodiments of the invention. Alternate embodiments may be devised without departing from the spirit or the scope of the invention. Additionally, well-known elements of exemplary embodiments of the invention will not be described in detail or will be omitted so as not to obscure the relevant details of the invention. Further, to facilitate an understanding of the description discussion of several terms used herein follows.

As used herein, the word “exemplary” means “serving as an example, instance or illustration.” The embodiments described herein are not limiting, but rather are exemplary only. It should be understood that the described embodiments are not necessarily to be construed as preferred or advantageous over other embodiments. Moreover, the terms “embodiments of the invention.”, “embodiments” or “invention” do not require that all embodiments of the invention include the discussed feature, advantage or mode of operation.

According to an exemplary embodiment, and referring generally to the Figures, various exemplary embodiments of sew free seamless interior woven label and automated application may be shown and described.

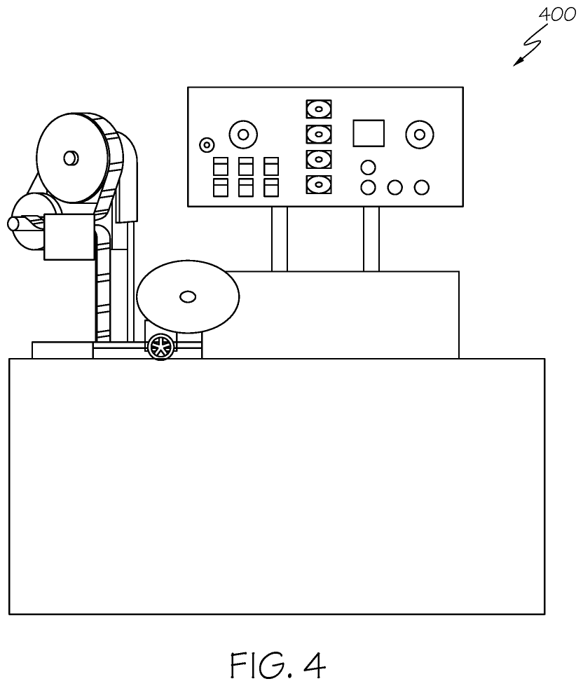

According to an exemplary embodiment, such method, system, and apparatus for a sew free seamless interior woven label application shown and described can make the garment manufacturing process and woven label application process more efficient, eliminate waste, enhance visual appeal of the final garment product, and reduce manufacturing costs, among other advantages. An automated applicator 400, as shown in exemplary FIG. 4, can apply weaving fusible yarn, such as but not limited to thermo-adhesive heat seal yarn to the interior, different faces, or fold backs of a woven label. The woven label with applied weaving fusible thermo-adhesive heat seal yarn can be placed on the garment in a desired location and an applicator can apply heat onto the woven label, thus activating the weaving fusible thermo-adhesive heat seal yarns and affixing the woven label to a material or to the garment in the desired location. The garment may be a clothing item like a shirt, sweater or pants. The garment may also be a pair of gloves or any wearable accessory item. In addition, the heat activation can be used for both internal and external labels. The applicator temperature may be adjustable during application. The applicator's temperature may be adjusted via a touchscreen user interface found on the applicator in one embodiment. The applicator is any type of press contemplated in the art, such as a heat press with a bottom and upper plate that is pressing the label on to the fabric/garment via heat and pressure. In one embodiment presently contemplated, heat application is accomplished at 150° C., 10-12 Sec and 1,5 Kg/cm. In another embodiment, a lower application temperature would be utilized in order to reduce the damaging of any materials. Furthermore, the applicator may also communicate and/or display information and attributes related to the application process as well as the external label being created. For example, the applicator may display a completion update i.e. “5 of 10 complete”. The applicator may further comprise visual and/or audio feedback. Audio and/or visual feedback may be triggered as configured by the user. For example, the audio and/or visual feedback of the applicator may be triggered upon woven label completion, error upon application, overheating, temperature of applicator is outside an acceptable threshold for use.

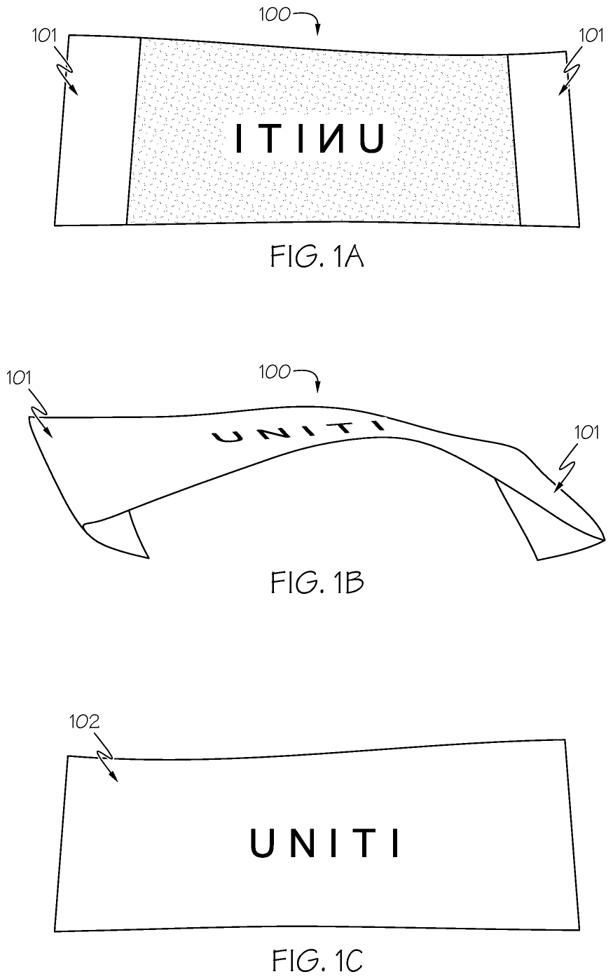

FIGS. 1A and 1B provide multiple embodiments of a woven label 100 with an applied yarn 101. The woven label 100 may be constructed by weaving fusible thermo-adhesive heat seal yarns placed on an area like the back folds (areas) of a substrate forming the woven label. The woven label 100 is then in a place on an article where normally stitching would be used to affix the label to the garment. The present invention contemplates that any kind of yarn may be used to produce the base of the woven label such as, but not limited to, recycled polyester, natural yarns (i.e. cotton, wool). However, at least one heat seal yarn may be utilized in the overall construction of the woven label such that the at least one heat seal yarn may be affixed on back folds of the woven label on either side for a uniform adhesive effect onto the garment. A distinguishing aspect of the present invention is that thermo-adhesive, heat seal yarns are used as a component of the label of—such as on either the top or bottom face of the label construction—so those yarns can be activated and function as the bond of the label to a material. The at least one fusible thermo-adhesive heat seal yarn 101 may be activated through heat application, such as through a heat bonder or other suitable source known in the art. While the present invention discusses heat application, the present invention also contemplates the utilization of a cold transfer as well. Once heat is applied to the weaving fusible thermo-adhesive heat seal yarn 101 the seal will affix to the garment surface, substantially permanently or permanently to which the woven label is applied. Ideally, the bonding should be sufficiently strong so that if the label is attempted to be removed such as by application of force, the garment will slow or inhibit the removal, such as by exhibiting some level of fiber tear. Thus, the peel force strength, which is dependent on the type of fabric or material utilized for the label should be sufficiently strong to prevent removal. In another embodiment where the woven label 100 has multiple back folds, the heat seal yarn 101 may be affixed on back folds of the woven label on all sides, for a completely uniform adhesive effect onto the garment.

Still referring to FIGS. 1A and 1B, FIGS. 1A and 1B further provide a woven label 100 that utilizes fusible thermo-adhesive heat seal yarn after it has been affixed to an exemplary garment. FIG. 1C shows the woven label 102 is now attached to the exemplary garment only in the two locations 101, 102 in which the weaving fusible thermo-adhesive heat seal yarn were applied. This allows for the rest of the woven label to be free from the exemplary garment as shown in FIG. 1B. The present invention is not limited to any number of locations in which the fusible thermo-adhesive heat seal yarn were applied and the label may be applied to a material or garment at any number of locations wherever the fusible thermo-adhesive heat seal yarns are present. The present invention also contemplates that the label may be attached to a material at other areas in which the fusible thermo-adhesive yarns are not present so that the overall label construction is attached to a material at a variety of locations—some locations with the thermo-adhesive yarns and others that no possess such yarns.

FIG. 1C also provides, in 102, a woven label with weaving fusible thermo-adhesive heat seal yarn after heat had been applied and the woven label had become affixed to the exemplary garment. FIG. 1C shows the woven label 102 as it is pressed flush against the exemplary garment, for example so that adhesive covers an entire back portion of label 102, in a different style than above. The present invention contemplates that the adhesive is curtain coated or pattern coated onto a portion of the label 102.

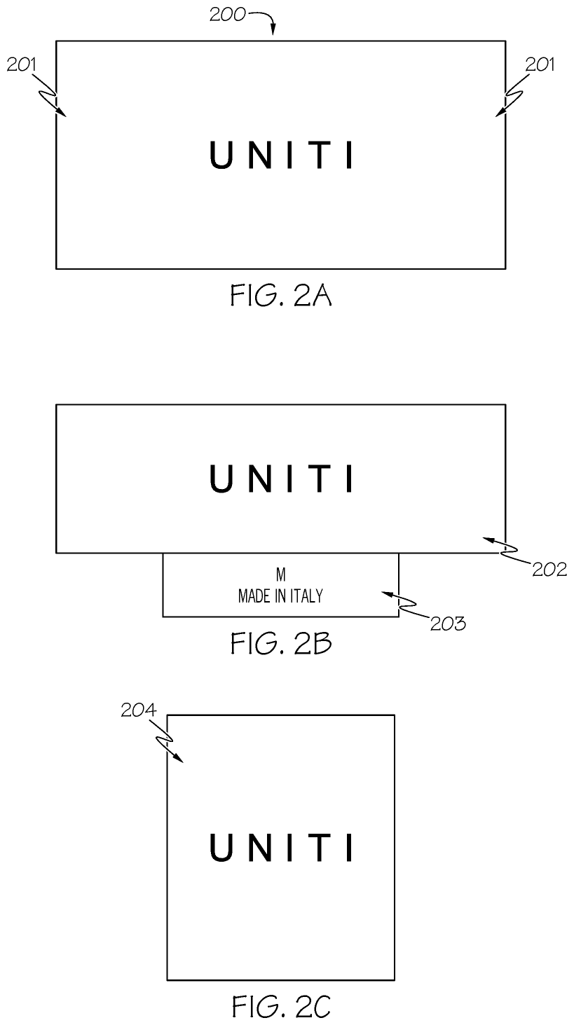

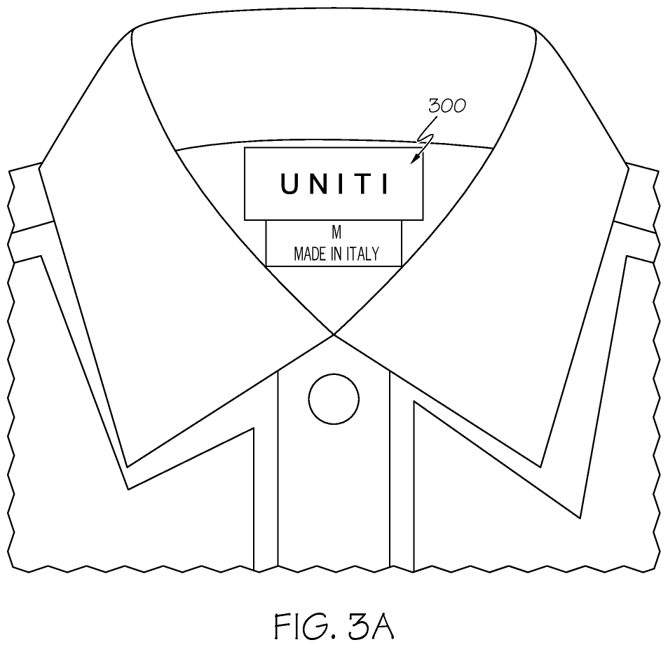

Next, referring to exemplary FIG. 2A, FIG. 2A provides a woven label 200 with weaving fusible thermo-adhesive heat seal yarn after heat had been applied and the woven label had become affixed to the exemplary garment. Heat seal yarn can be applied in a plurality of locations such as in two locations 201 such that the woven label can be affixed to the garment at those locations. In one embodiment presently contemplates, the heat seal yarn can be applied to a perimeter of the woven label 300. The yarn may be applied around portions of the perimeter, substantially around the perimeter and entirely around the perimeter of the woven label construction 200.

Still referring to exemplary FIG. 2B, FIG. 2B provides a woven label 202 affixed to the exemplary garment by weaving fusible thermo-adhesive heat seal yarn throughout a label, combined with at least one other woven label 203 also affixed by a weaving fusible thermo-adhesive heat seal yarn. The present invention is not limited to any number of woven labels and the utilization of two woven labels in the FIG. 2B is for illustration purposes only. FIG. 2B also contemplates that both the first and second woven labels (202 and 203) have perimeters and the fusible thermo-adhesive heat seal yarns may be applied to the perimeters of both or one of the labels 202 and 203 and entirely around the perimeters or substantially around the perimeter. The present invention contemplates that the first woven label 202 may be affixed by the same or different means as label 203. The second, which in one embodiment is smaller in size than woven label 203 is affixed to the exemplary garment by a weaving fusible thermo-adhesive heat seal yarn. The present invention also contemplates that both woven labels 202 and 203 have substantially the same area and thus are similar in size.

FIG. 2B demonstrates the exemplary versatility the sew free seamless interior woven label application system provides to manufacturers, allowing manufacturers ease in affixing more complex woven labels onto garments. The exemplary method, system and apparatus can make the garment manufacturing process and woven label application process of more complex woven label designs more efficient, eliminate waste, enhance visual appeal of the final garment product, and reduce manufacturing costs, among other advantages.

Additionally, FIG. 2C can also provide a woven label 204 with weaving at least one fusible thermo-adhesive heat seal yarn after heat had been applied and the woven label 204 had become affixed to the exemplary garment. FIG. 2C shows the woven label 204 as it is pressed flush against the exemplary garment. Further, FIG. 2C further demonstrates exemplary advantages of the method, system and apparatus, as applied to different types of woven labels. The disclosed method, system, and apparatus can be equally effective or utilized on all woven labels no matter the size, shape, or orientation or the woven label.

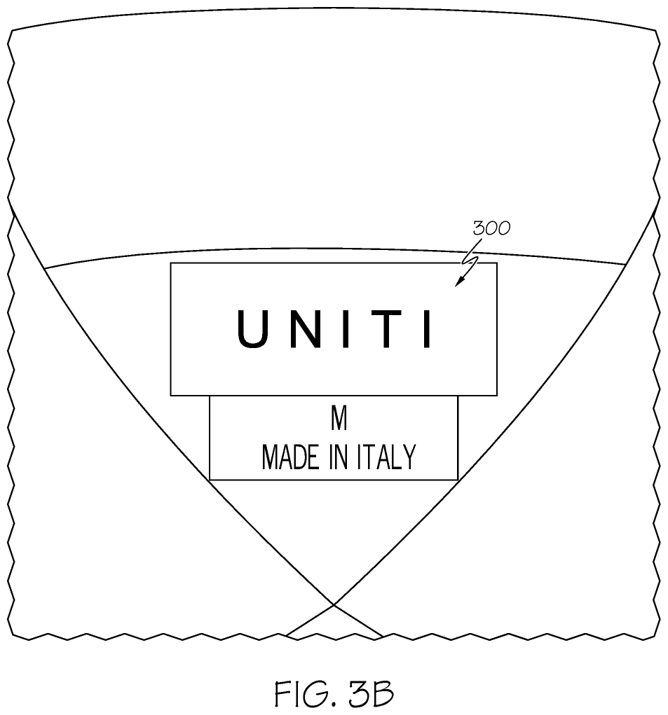

Referring now to exemplary FIGS. 3A and 3B, FIGS. 3A and 3B provide a woven label 300 with at least one fusible thermo-adhesive heat seal yarn after heat had been applied and the woven label had become affixed to the exemplary garment. FIGS. 3A and 3B provide an exemplary view of the woven label after it is pressed flush against the exemplary garment, for example so that it will not cause irritation to the end consumer while wearing the exemplary garment. Additionally, similar to the exemplary embodiments shown in FIGS. 2A, 2B, and 2C, FIGS. 3A and 3B can also demonstrate the versatility a sew free seamless interior woven label application system provides to manufacturers, allowing manufacturers ease in affixing more complex woven labels onto garments. Exemplary methods, systems and apparatuses described herein can make the garment manufacturing process and woven label application process of more complex woven label designs more efficient, eliminate waste, enhance visual appeal of the final garment product, and reduce manufacturing costs, among other advantages.

Turning now to exemplary FIG. 4, a machine 400 that can perform the steps described and displayed with respect to exemplary FIGS. 1A, 1B, 1C, 2A, 2B, 2C, 3A, and 3B may be shown. The exemplary machine may include a variety of components which may be substantially automated in order to efficiently apply the weaving fusible thermo-adhesive heat seal yarn to the desired woven labels and described in exemplary embodiments herein, and further to place the woven labels onto the desired garment in a desired location, and apply heat to affix the woven label with weaving fusible thermo-adhesive heat seal yarn to the garment. The machine may be used to facilitate the affixing of woven labels with weaving fusible thermo-adhesive heat seal yarn to desired garments. Such a machine employing exemplary embodiments of the method, system and apparatus can make the garment manufacturing process and woven label application process more efficient, eliminate waste, enhance visual appeal of the final garment product, and reduce manufacturing costs, among other advantages.

An additional embodiment includes the weaving of thermo-adhesive heat seal yarn on the full length on the back of the woven label in addition to the fold areas to create a four side sew label.

The woven label of the present invention can also be used for external embellishments that appear on the exterior of the garment or item to which the woven label is applied. For example, using the thermo activated heat seal yarns would be applied as contemplated by this invention and then the label affixed to the outside of the garment, to provide branding or other aesthetic elements.

The present invention also contemplates using an inkjet printer which can be used to apply additional indicia to the woven label on a face of the woven label, whether fixed or variable information, for example the inkjet printer could be used to apply a unique serial number to the label as part of a brand authentication program. The indicia may include a trademark, a company brand logo or some sort of illustration.

The present invention additionally contemplates that various adhesives may further supplement the use of the thermos-activated heat seal yarns on woven labels. The woven label may have thermo-adhesive heat seal yarn on at least one of multiple back folds and additionally have a supplemental adhesive on the portions of the back label not covered by the thermos-adhesive label. An additional embodiment includes the weaving of thermo-adhesive heat seal yarn on the full length on the back of the woven label in addition to the fold areas to create a four side sew label. In yet another embodiment, multiple (at least two), weavable fusible thermo-adhesive heat seal yarns may be employed to create the desired woven label. In said embodiment, at least one of the thermo-adhesive yarns may be of a different color, thickness and/or length than the other thermo-adhesive yarns.

In one embodiment presently contemplated, the label of the present invention may incorporate radio frequency identification (RFID) technology within it, and in another embodiment, the label may incorporate combined RFID and electronic article surveillance (EAS) technology as well.

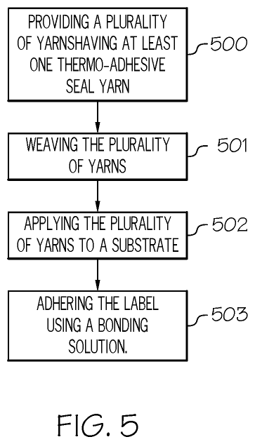

The present invention also contemplates a method of making the present invention as illustrated in FIG. 5 of the present invention. First, a plurality of yarns are provided in step 500. Then the yarns, which include at least one thermo-adhesive heat seal yarns are woven by methods known in the art 501. Next, the plurality of yarns are applied to a substrate to form a woven label 502. The label is then applied via a bonding method, such as heat activated bonding, to a material 503. The method of making may also include the step of determining the registration of the sew free seamless interior woven label.

The foregoing description and accompanying figures illustrate the principles, preferred embodiments and modes of operation of the invention. However, the invention should not be construed as being limited to the particular embodiments discussed above. Additional variations of the embodiments discussed above will be appreciated by those skilled in the art (for example, features associated with certain configurations of the invention may instead be associated with any other configurations of the invention, as desired).

Therefore, the above-described embodiments should be regarded as illustrative rather than restrictive. Accordingly, it should be appreciated that variations to those embodiments can be made by those skilled in the art without departing from the scope of the invention as defined by the following claims.

What is claimed is:

1. A method for a sew free seamless interior woven label application, comprising the steps of;
providing a plurality of yarns having at least one thermo-adhesive seal yarn;
weaving the plurality of yarns;
applying the plurality of yarns to a substrate to form the label; and
adhering the label using a bonding solution.

2. The method of claim 1, wherein an automated process is utilized to apply the at least one heat seal yarn to a back of the label

3. The method of claim 2, wherein the automated process utilizes the application of heat to the woven labels.

4. The method of claim 1, wherein the woven label is affixed to a garment after adhering the label using a bonding solution.

5. The method of claim 4, wherein woven label is attached to the garment only where the at least one fusible thermo-adhesive heat seal yarn is present.

6. The method of claim 5, wherein an applicator is used to attach the label to the garment and heat application is accomplished at 150° C., 10-12 Sec and 1,5 Kg/cm.

7. The method of claim 1, wherein the at least one thermo-adhesive heat seal yarn is applied to an interior or fold backs of the substrate.

8. A woven label comprising:
a plurality of yarns such that at least one yarn is a fusible thermo-adhesive heat seal yarn;
and the at least one fusible thermo-adhesive heat seal yarn is on a top or bottom face of the woven label and is activated via a heat application.

9. The woven label of claim 8, wherein the plurality of yarns comprises recycled polyester.

10. The woven label of claim 8, wherein the plurality of yarns comprises cotton.

11. The woven label of claim 8, wherein the top face of the label comprises indicia.

12. The woven label of claim 8, wherein the label incorporates radio frequency identification (RFID) technology.

13. A material having a plurality of woven labels comprising;
a first label;
a second woven label;
wherein either the first and/or second woven label comprise heat seal yarn and the first and second woven label have different areas.

14. The material of claim 12, wherein the first and second labels each have a perimeter.

15. The material of claim 14, wherein the heat seal yarn is applied to the perimeter of the first label.

16. The material of claim 14, wherein the heat seal yarn is applied to the perimeter of the second label.
